(19) United States
(12) Patent Application Publication
(10) Pub. No.: US 2016/0121450 A1
(43) Pub. Date: May 5, 2016

(54) POWER TOOL COUNTERWEIGHT ARRANGEMENT AND MASS MEMBER

(71) Applicant: Black & Decker Inc., Newark, DE (US)

(72) Inventors: Philip T. Miller, Phoenix, MD (US); Daniel H. Sides, JR., New Freedom, MD (US); Qiang J. Zhang, Lutherville, MD (US); Thomas F. Doehner, York, PA (US)

(21) Appl. No.: 14/925,671

(22) Filed: Oct. 28, 2015

Related U.S. Application Data
(60) Provisional application No. 62/074,936, filed on Nov. 4, 2014.

(51) Int. Cl. B24B 23/03; B23Q 11/00

(52) U.S. Cl. CPC B24B 23/03; B23Q 11/0035

(57) ABSTRACT

A power tool may include a motor and a drive shaft having a first end coupled to the motor and a second end eccentrically coupled to a platen by a retainer bearing and eccentric sleeve. A counterweight component may be coupled to the second end of the drive shaft to counteract imbalance generated by rotation of the retainer bearing, eccentric sleeve and platen. The counterweight component may include a counterweight coupled to the second end of the drive shaft, between the eccentric sleeve and the platen. Alignment of the counterweight may be offset with respect to a centerline of the drive shaft to counteract vibration generated due to interaction of the platen with a workpiece. The counterweight component may also include a counterweight mass member coupled to a sector of the counterweight to counteract vibration generated due to interaction of the platen with a workpiece.

### CROSS-REFERENCE TO RELATED APPLICATION

This application claims the benefit of U.S. Provisional Application Ser. No. 62/074,936, filed Nov. 4, 2014, titled “Power Tool Counterweight Arrangement And Mass Member,” which is incorporated herein by reference in its entirety.

### FIELD

This document relates, generally, to a power tool, and in particular, to a power tool for sanding a workpiece.

### BACKGROUND

Power tools, and in particular, power tools used to provide a desired surface finish on a workpiece, may include, for example, polishers, sheet sanders, random orbit sanders, and the like. Some of these types of power tools may employ an eccentric motion to remove material from the surface of the workpiece, and improve surface finish.

### SUMMARY

In one aspect, a power tool may include a housing, a motor in the housing, a drive shaft, a first end portion of the drive shaft being coupled to the motor, a platen, a retainer bearing coupled to a first surface of the platen, an eccentric sleeve coupled to a second end portion of the drive shaft, the eccentric sleeve being coupled in the retainer bearing to eccentrically couple the drive shaft to the platen, and a counterweight coupled to the second end portion of the drive shaft, between the first surface of the platen and the eccentric sleeve. The counterweight may be positioned such that a counterweight axis defined along a radial centerline of the counterweight is offset by a predetermined angle with respect to an orbit radius axis of an eccentric mass including eccentric sleeve, retainer bearing and platen coupled to the second end portion of the drive shaft.

In another aspect, a power tool may include a motor, a drive shaft, a first end portion of the drive shaft being coupled to the motor, a platen, a retainer bearing coupled to a first surface of the platen, an eccentric sleeve coupled to a second end portion of the drive shaft, the eccentric sleeve being coupled in the retainer bearing to eccentrically couple the drive shaft to the platen, a counterweight coupled to the second end portion of the drive shaft, between the first surface of the platen and the eccentric sleeve, and a mass member included on the counterweight, positioned on a peripheral diametric edge portion of the counterweight.

In another aspect, a power tool may include a motor, a drive shaft, a first end portion of the drive shaft being coupled to the motor, a platen, a retainer bearing coupled to the platen, a fan coupled to the drive shaft, the fan including a first counterweight and a hub portion, the drive shaft extending through an opening in the hub portion, a sleeve coupled to the hub portion of the fan, the sleeve being coupled in the retainer bearing, and a second counterweight coupled to a second end portion of the drive shaft, between the first surface of the platen and the sleeve.

The details of one or more implementations are set forth in the accompanying drawings and the description below. Other features will be apparent from the description and drawings, and from the claims.

### BRIEF DESCRIPTION OF THE DRAWINGS

FIG. 1A is a perspective view of an example implementation of an eccentric motion power tool, and FIG. 1B is an exploded view of the tool shown in FIG. 1A.

FIGS. 2A and 2B are bottom views of a sanding tool, and FIG. 2C is a cross-sectional view of the sanding tool shown in FIGS. 2A and 2, in accordance with embodiments as broadly described herein.

FIG. 2D is a graph of vibration levels of sanding tools having counterweights positioned at varying offset angles, and with varying orbit radii, in accordance with embodiments as broadly described herein.

FIG. 3A is a bottom view of a sanding tool, and FIG. 3B is a cross-sectional view of the sanding tool shown in FIG. 3A, in accordance with embodiments as broadly described herein.

FIG. 4 is a cross-sectional view of a sanding tool, in accordance with embodiments as broadly described herein.

### DETAILED DESCRIPTION

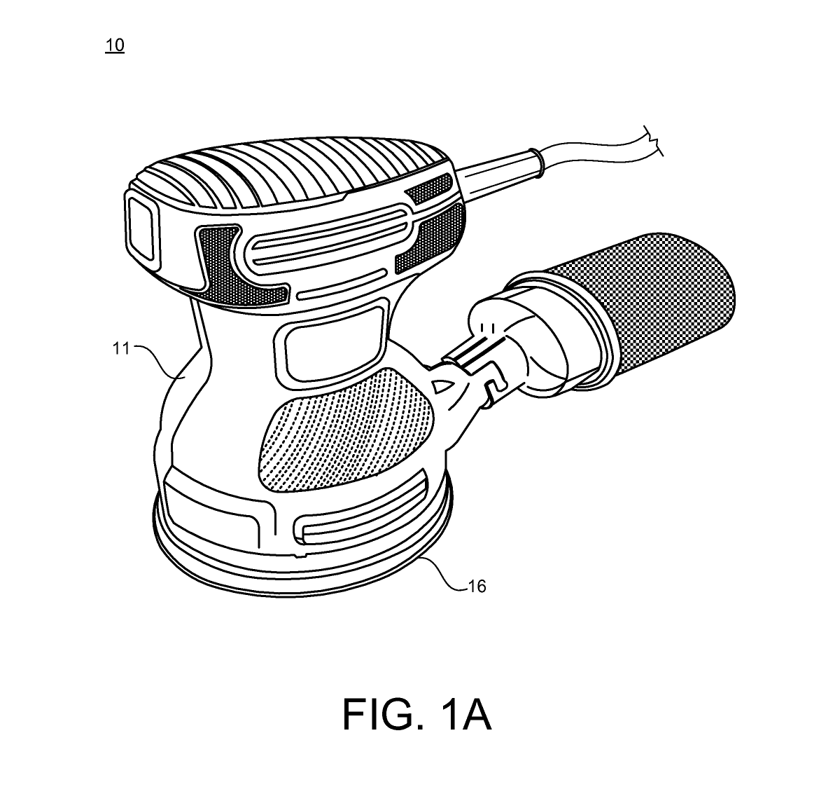

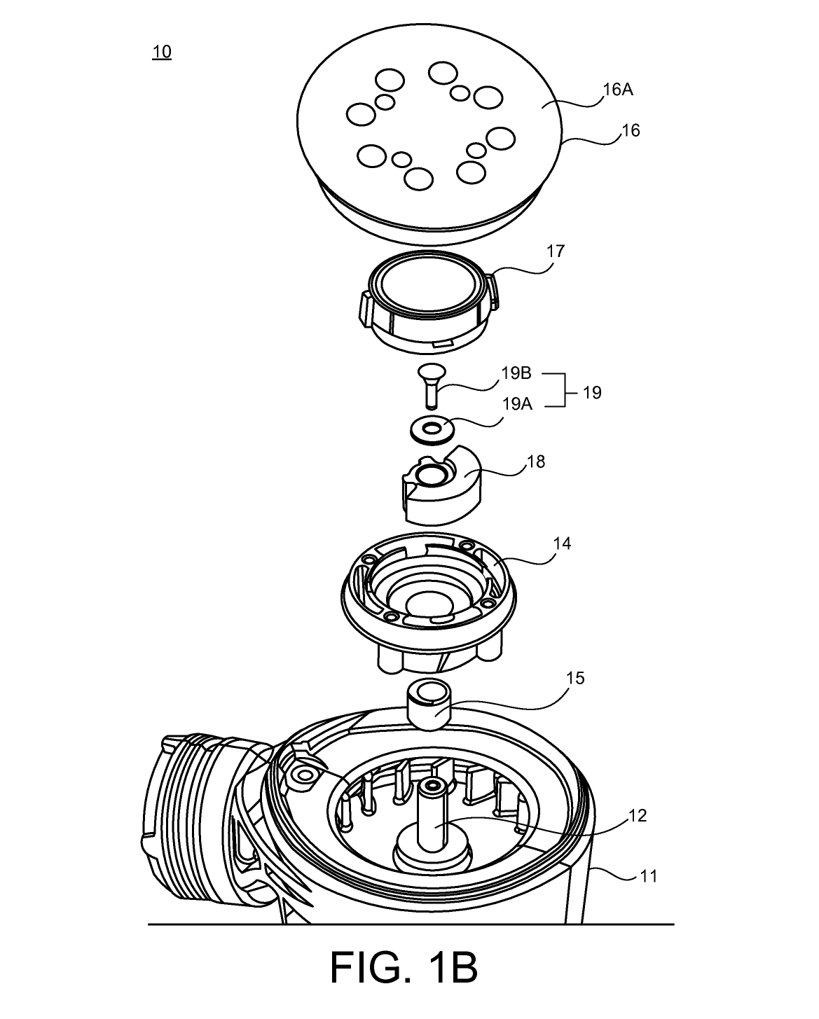

An example implementation of an eccentric motion power tool is shown in FIGS. 1A-1B. The exploded view of the example sanding tool 10 shown in FIG. 1B illustrates a housing 11 in which a motor is received, the motor rotating a drive shaft 12. A sanding platen 16, or sanding pad 16, may include a substantially planar outer surface 16A to which an abrasive finishing sheet, such as, for example, sandpaper may be affixed. A bearing retainer 14 may be positioned on an inner surface of the platen 16, at a location that is eccentric to the drive shaft 12, with an eccentric sleeve 15 coupling the drive shaft 12 to the retainer bearing 14, to convert the rotational force of the motor transmitted by the drive shaft 12 into an orbital movement of the platen 16.

To counteract imbalance in the eccentric coupler 15/retainer bearing 14/platen 16 generated due to the eccentric coupling of the platen 16 to the drive shaft 12 during operation, in some embodiments, the tool 10 may include a counterweight 18 coupled to the drive shaft 12. A coupling device 19, such as, for example, a washer 19A and a fastener 19B, may couple the counterweight 18 in position at the end of the drive shaft 12, with a dust cap 17 covering the assembled counterweight 18 and drive shaft 12. In some embodiments, the counterweight 18 may be positioned opposite the center of gravity of the platen 16, for example, approximately 180 degrees from the center of gravity of the platen 16. Positioning of the counterweight 18 in this manner may counteract imbalance and reduce vibration when the motor is rotating the drive shaft 12. However, when the platen 16, and in particular, a sheet of sandpaper attached to the outer surface 16A of the platen 16, contacts a workpiece during operation, vibration of the tool 10 may increase due to additional external forces introduced by resistance between the finishing surface of the workpiece and the sandpaper.

To counteract an additional force, or force vector, generated due to the resistance between the finishing surface of the workpiece and the sandpaper, in some embodiments, the counterweight may be arranged at a relatively small offset angle with respect to an orbit radius axis. In some embodiments, the counterweight may be positioned as close to the source of this additional vibration and/or imbalance as possible, for example, as close to the lower surface of the platen as possible, for example, between the bearing retainer and the lower surface of the platen. Arranging the counterweight at a relatively small offset angle with respect to the orbit axis radius, and/or arranging the counterweight as close to the lower surface of the platen as possible may balance the rotating masses to reduce vibration and counteract the force vector generated due to the interaction between the sandpaper and the workpiece, thus reducing effective vibration of the tool engaged with a workpiece during operation.

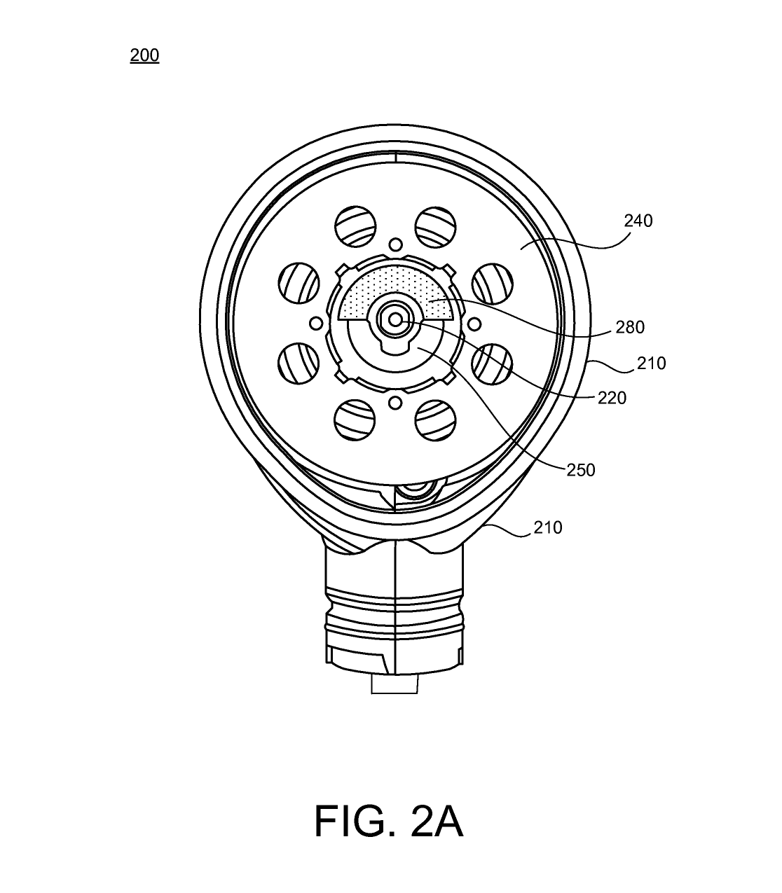

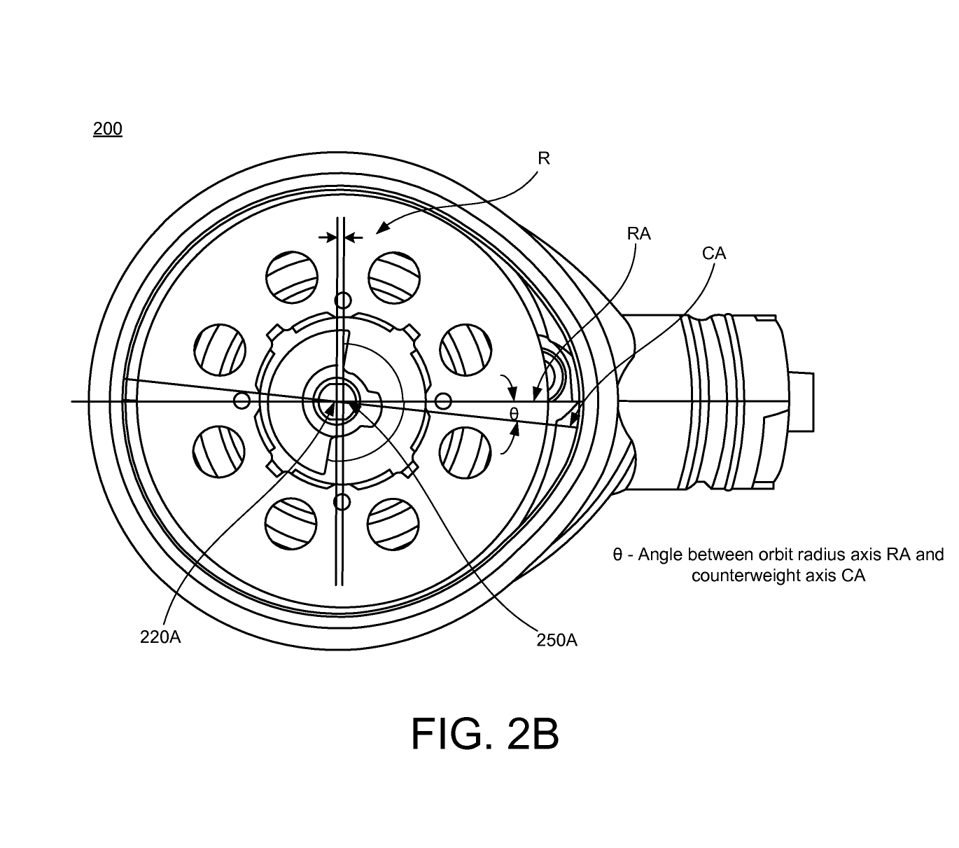

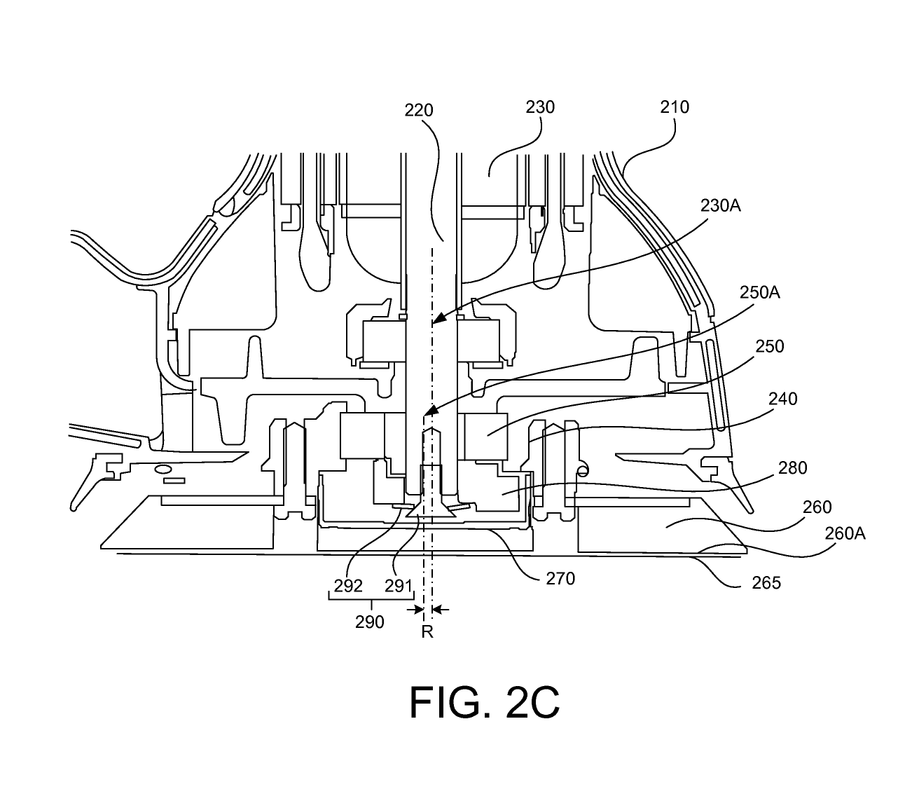

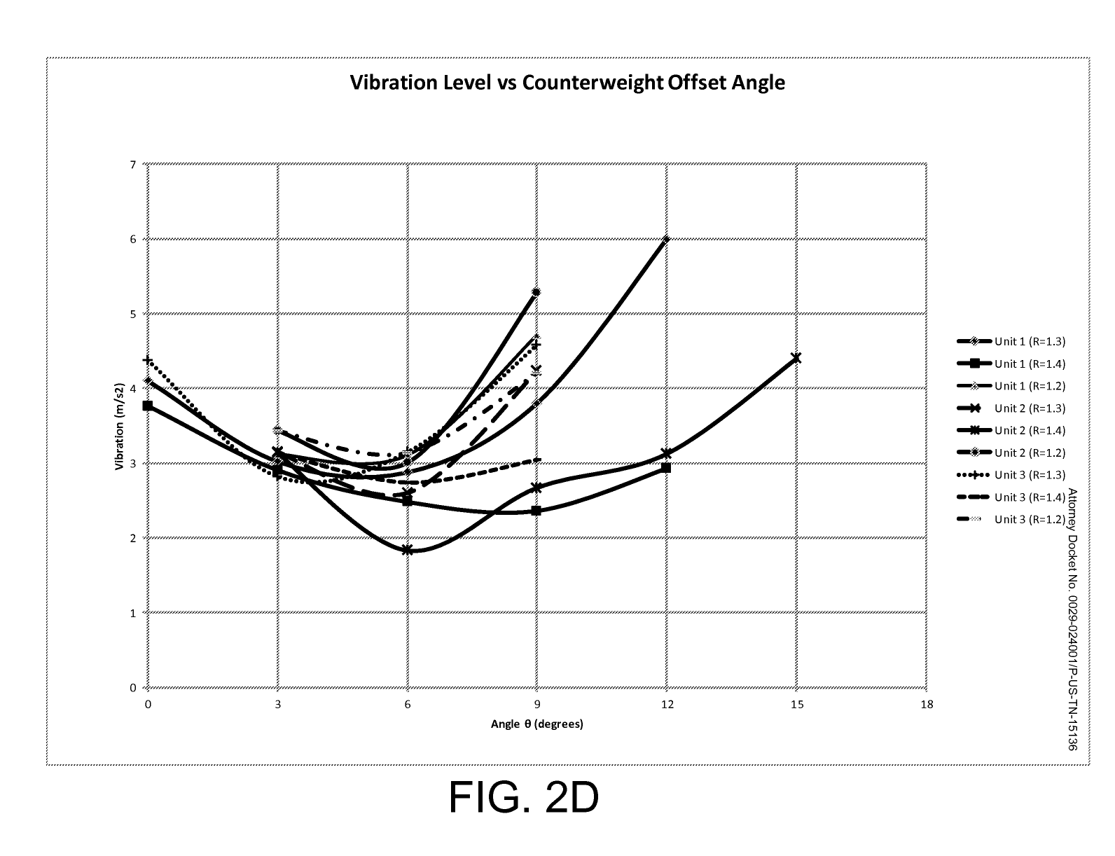

FIGS. 2A and 2B are bottom views of a sanding tool 200, in accordance with an example implementation as broadly described herein, with a platen and a dust cap of the sanding tool 200 removed so that an arrangement of internal components is visible, and FIG. 2C is a cross-sectional view of the sanding tool 200 shown in FIGS. 2A and 2B.

As shown in FIGS. 2A and 2B, the tool 200 may include a housing 210 in which a drive shaft 220 driven by a motor 230 is housed. The drive shaft 220 may be rotated by the motor 230 about a driven shaft centerline 220A. An eccentric sleeve 250 may be eccentrically positioned around a distal end portion of the drive shaft 220, centered about an eccentric mass centerline 250A that is offset from the driven shaft centerline 220A. The eccentric sleeve 250 may be retained by a bearing retainer 240 surrounding the eccentric sleeve 250, with the bearing retainer 240 coupled to an inner surface portion of a platen 260, or sanding pad 260. The platen 260 may include an outer surface 260A to which an abrasive sheet 265, such as sandpaper, may be affixed. A counterweight 280 may be coupled to the distal end of the drive shaft 220, between the bearing retainer 240/eccentric sleeve 250 and the platen 260. A coupling device 290, including, for example, a fastener 291 extending through a washer 292 positioned in a recess of the counterweight 280 and into the distal end portion of the drive shaft 220, may couple the counterweight 280 in position relative to the bearing retainer 240, eccentric sleeve 250 and drive shaft 220, with a dust cap 270 positioned between the end of the assembled components and the platen 260.

As shown in FIGS. 2B and 2C, an orbit radius R may be defined by a distance between the driven shaft centerline 220A and the eccentric mass centerline 250A, with an orbit radius axis RA defined by a line extending laterally through the longitudinally extending driven shaft centerline 220A and the longitudinally extending eccentric mass centerline 250A. A counterweight axis CA may be defined by a line radially bisecting the counterweight 280, with an angle θ formed between the orbit radius axis RA and the counterweight axis CA. The angle 0θ may define an offset angle of the counterweight 280 with respect to the orbit radius axis RA. Offset of the counterweight 280, for example by the offset angle θ, and proximity of the counterweight 280 to the outer surface 260A of the platen 260, may counteract imbalance, and may reduce vibration of the tool 200 engaged with a workpiece during operation.

In some embodiments, the offset angle θ may be greater than 0.0 and less than or equal to approximately 9.0 degrees to achieve a desired reduction in vibration levels. In some embodiments, the offset angle θ may be greater than 0.0 degrees and less than or equal to 6.0 degrees to achieve a desired reduction in vibration levels. In some embodiments, the offset angle θ may be between approximately 6.0 degrees and 9.0 degrees to achieve a desired reduction in vibration levels. In some embodiments, arrangement of the counterweight so that a portion of the counterweight mass is located as close to the plane of the workpiece as possible, and at an relatively small offset angle with respect to the orbit radius, as described above, may reduce vibration by up to approximately 40%, depending on, for example, orbit radius, operation speed and the like. For example, in one implementation, a tool vibration level, when the tool is actively engaged with a workpiece during operation, may be less than approximately 2.5 m/s². Various combinations of orbit radius R, offset angle θ and resulting reductions in vibration levels are shown in Table 1 below.

TABLE 1

| | Orbit | | | | |
|---|---|---|---|---|---|
| | Radius R | Angle θ | Vibration (m/s²) | | |
| Combination | (mm) | (Degrees) | Unit 1 | Unit 2 | Unit 3 |
| 1 | 1.3 | 0 | 4.1 | | 4.4 |
| 2 | 1.3 | 3 | 3.0 | 3.1 | 2.8 |
| 3 | 1.3 | 6 | 2.9 | 2.6 | 3.1 |
| 4 | 1.3 | 9 | 3.8 | 4.2 | 4.6 |
| 5 | 1.3 | 12 | 6.0 | — | — |
| 6 | 1.4 | 0 | 3.8 | — | — |
| 7 | 1.4 | 3 | 2.9 | 3.1 | 3.1 |
| 8 | 1.4 | 6 | 2.5 | 1.8 | 2.7 |
| 9 | 1.4 | 9 | 2.4 | 2.7 | 3.0 |
| 10 | 1.4 | 12 | 2.9 | 3.1 | — |
| 11 | 1.4 | 15 | — | 4.4 | — |
| 12 | 1.2 | 3 | 3.1 | 3.4 | 3.4 |
| 13 | 1.2 | 6 | 3.1 | 3.0 | 3.1 |
| 14 | 1.2 | 9 | 4.7 | 5.3 | 4.2 |

As shown in Table 1 above, and in the graph of FIG. 2D, example implementations of sanding tools, units 1, 2 and 3, may achieve varying reductions in vibration level when the counterweight is positioned at a relatively small offset angle θ. The graph shown in FIG. 2D illustrates vibration levels for three different units 1, 2 and 3, taken at three different orbit radii (1.2 mm, 1.3 mm and 1.4 mm), ranging from an offset angle θ of approximately 0.0 degrees to an offset angle θ of approximately 12.0 degrees.

For example, in a first example implementation of a sanding tool represented by combination 3 in Table 1, an example orbit radius of 1.3 mm and an offset angle of approximately 6.0 degrees may result in a vibration level of approximately 2.6 m/s², resulting in an approximately 30% reduction in vibration compared to the same tool having an orbit radius of 1.3 mm, but with the counterweight aligned with the driven shaft centerline (i.e., an offset angle of 0.0 degrees). In a second example implementation, represented by combination 8 in Table 1, an example orbit radius of 1.4 mm and an offset angle of approximately 6.0 degrees may result in a vibration level of approximately 2.5 m/s², resulting in an approximately 34% reduction in vibration compared to the same tool having an orbit radius of 1.4 mm, but with the counterweight aligned with the driven shaft centerline (i.e., an offset angle of 0.0 degrees). In a third example implementation, represented by combination 9 in Table 1, an example orbit radius of 1.4 mm and an offset angle of approximately 9.0 degrees may result in a vibration level of approximately 2.4 m/s², resulting in an approximately 37% reduction in vibration compared to the same tool having an orbit radius of 1.4 mm, but with the counterweight aligned with the driven shaft centerline (i.e., an offset angle of 0.0 degrees).

As noted above, arrangement of the counterweight so that at least a portion of the counterweight mass is located as close to the plane of the workpiece as possible, and at an relatively small offset angle with respect to the orbit radius, rather than aligned with the driven shaft centerline, as described above, may reduce vibration to varying degrees, depending on various factors associated with a particular tool implementation, such as, for example, orbit radius, operation speed and the like.

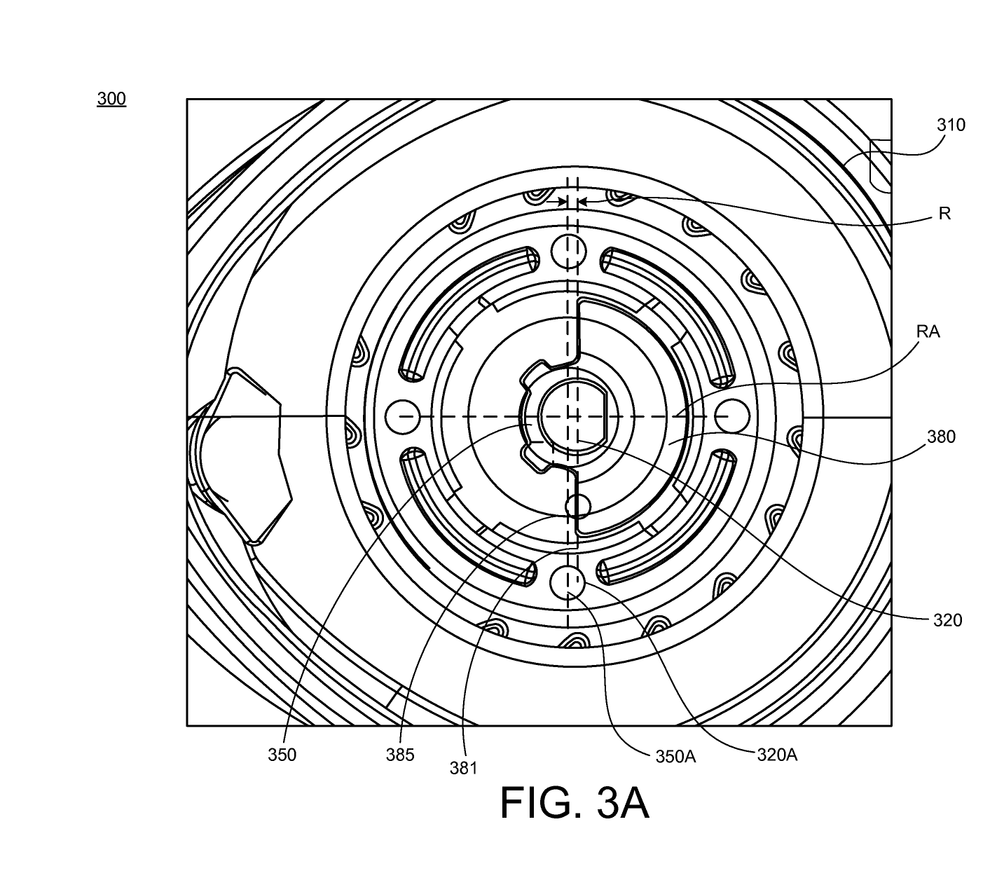

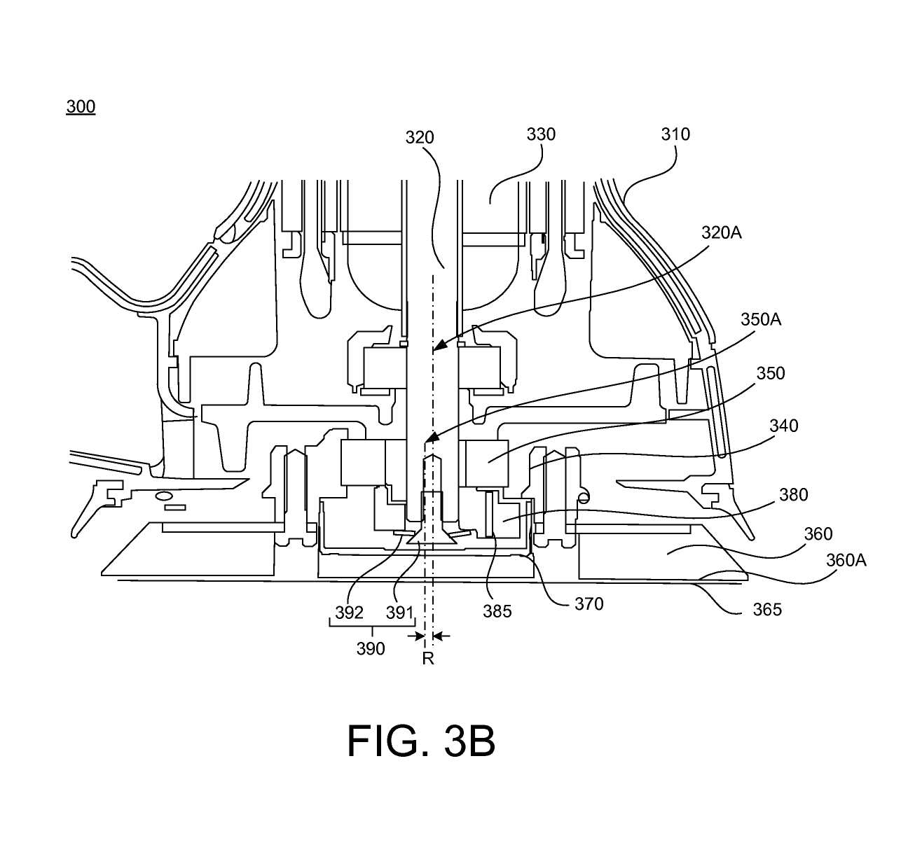

FIG. 3A is a bottom view of a sanding tool 300, in accordance with an example implementation as broadly described herein, with a platen and a dust cap of the sanding tool 300 removed so that an arrangement of internal components is visible, and FIG. 3B is a cross-sectional view of the sanding tool 300 shown in FIG. 3A.

The tool 300 may include a housing 310 housing a drive shaft 320 driven by a motor 330 to rotate about a driven shaft centerline 320A, with an eccentric sleeve 350 eccentrically positioned around a distal end portion of the drive shaft 320, centered about an eccentric mass centerline 350A, and retained by a bearing retainer 340 that is coupled to an inner surface portion of a platen 360, similar to the tool 200 described above with respect to FIGS. 2A-2C. The platen 360 may include an outer surface 360A to which an abrasive sheet 365, such as sandpaper, may be affixed. A counterweight 380 may be coupled to the distal end of the drive shaft 320, between the bearing retainer 340/eccentric sleeve 350 and the platen 360, by a coupling device 390, including, for example, a fastener 391 and a washer 392, with a dust cap 370 positioned between the end of the assembled components and the platen 360.

The counterweight 380 may include a counterforce mass member 385. The counterforce mass member 385 may be coupled to, or affixed to, or integral to the counterweight 380, and may be positioned to a particular sector of the counterweight 380, such as, for example, along a diameter line 381 of the counterweight 380. The counterforce mass member 385 may be made of the same material as the counterweight 380, or may be made of a different material than the counterweight 380. In the example implementation shown in FIGS. 3A and 3B, the counterforce mass member 385 is substantially cylindrical. However, a shape or contour, relative size, and/or positioning of the counterforce mass member may be different that the example shown in FIGS. 3A and 3B.

The counterforce mass member 385 may be positioned on the counterweight 380, on one side of the orbit radius axis RA opposite the remainder of the counterweight 380, to increase the weight on the one side of the counterweight 380. The additional mass added to the one side of the counterweight 380 by the counterforce mass member 385 may counteract imbalance and vibration generated by the rotating masses, that is, the rotation of the structure including the eccentric sleeve 350, bearing retainer 340 and platen 360, thus reducing vibration of the tool 300 engaged with a workpiece during operation.

As discussed above, in the example implementation shown in FIGS. 2A-2C, the counterweight 280 is offset by the offset angle θ to counteract imbalance and vibration generated by the rotating masses (for example, rotation of the structure including the eccentric sleeve 250, bearing retainer 240 and platen 260). In the example implementation shown in FIGS. 3A and 3B, the counterforce mass member 385 provided on the counterweight may counteract the imbalance and vibration generated by the rotating masses, without this type of angular offset of the counterweight 380.

The counterweight 380 and the counterforce mass member 385 may work together to counteract the imbalance and vibration generated by the rotating masses, and may reduce vibration of the tool 300 engaged with a workpiece during operation. In some embodiments, arrangement of the counterweight 380 and the counterforce mass member 385 so that a portion of the counterforce mass is located as close to the plane of the workpiece as possible, with the counterweight 380 and the counterforce mass member 385 positioned to counteract imbalance due to vibration generated by the rotating masses, may reduce vibration by up to approximately 40%, as discussed in detail above, so that when the tool 300 is actively engaged with a workpiece during operation, vibration may be less than approximately 2.5 m/s².

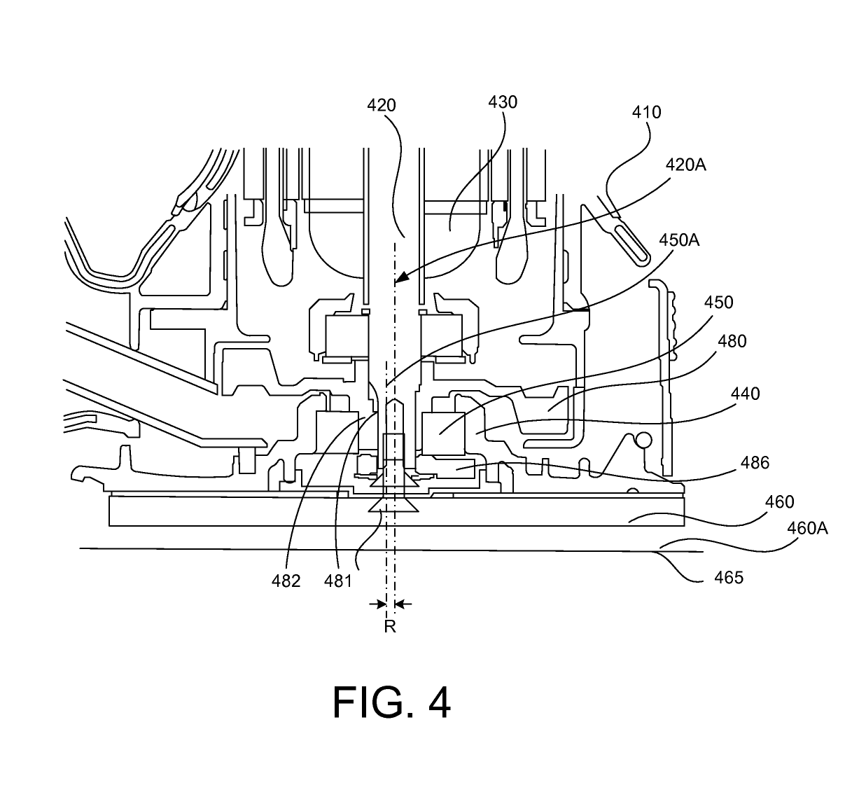

FIG. 4 is a cross-sectional view of a sanding tool 400, in accordance with an example implementation as broadly described herein.

The tool 400 may include a housing 410 housing a drive shaft 420 driven by a motor 430 to rotate about a driven shaft centerline 420A. A sleeve 450 may be retained by a bearing retainer 440 that is coupled to an inner surface portion of a platen 460, similar to the tool 200 described above with respect to FIGS. 2A-2C and the tool 300 described above with respect to FIGS. 3A-3B. The platen 460 may include an outer surface 460A to which an abrasive sheet 465, such as sandpaper, may be affixed.

A first counterweight 480, in the form of a weighted fan 480, may be positioned on the drive shaft 420, adjacent to the bearing retainer 440, to generate a flow of air within the housing 410 for cooling of the components received in the housing 410 and/or to direct finishing material/sanding dust removed from the workpiece into a collection receptacle. A distal end portion of the drive shaft 420 may be received in an opening 481 formed in a hub portion 482 of the fan 480. In some embodiments, the opening 481 may be eccentrically positioned in the hub 482, so that a first sector of the hub 482 includes more material than a second (opposite) sector of the hub 482, thus weighting the fan 480 in the area of the first (weighted) sector. In some embodiments, the distal end portion of the drive shaft 420 may be tapered in a portion of the drive shaft 420 corresponding to the weighted sector of the hub 482 of the fan 480. The hub portion 482 of the weighted fan 480 may be coupled in the sleeve 450 and the bearing retainer 440, which is in turn coupled to the platen 460. In some embodiments, a second counterweight 486 may be coupled to the distal end of the drive shaft 420, between the bearing retainer 440/sleeve 450/hub portion 482 of the weighted fan 480 and the platen 460.

The first counterweight 480 and the second counterweight 486 may work together to counteract the imbalance and vibration generated by the rotating masses, and may reduce vibration of the tool 400 engaged with a workpiece during operation. In some embodiments, arrangement of the first counterweight 480 and the second counterweight 486 so that a portion of the counterweight mass is located as close to the plane of the workpiece as possible, with the first counterweight 480 and the second counterweight 486 positioned to counteract imbalance due to vibration generated by the rotating masses, may reduce vibration by up to approximately 40%, as discussed in detail above, so that when the tool 400 is actively engaged with a workpiece during operation, vibration may be less than approximately 2.5 m/s².

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A power tool, comprising:
a housing;
a motor in the housing;
a drive shaft, a first end portion of the drive shaft being coupled to the motor;
a platen;
a retainer bearing coupled to a first surface of the platen;
an eccentric sleeve coupled to a second end portion of the drive shaft, the eccentric sleeve being coupled in the retainer bearing to eccentrically couple the drive shaft to the platen;
an eccentric mass, including the eccentric sleeve, the retainer bearing and the platen coupled to the second end portion of the drive shaft; and
a counterweight coupled to the second end portion of the drive shaft, between the first surface of the platen and the eccentric sleeve,
wherein the counterweight is positioned such that a counterweight axis defined along a radial centerline of the counterweight is offset by a predetermined angle with respect to an orbit radius axis of the eccentric mass.

2. The power tool of claim 1, wherein the orbit radius axis is defined by a line extending laterally through a longitudinally extending centerline of the drive shaft and a longitudinally extending centerline of the eccentric mass.

3. The power tool of claim 1, wherein the predetermined angle is greater than 0.0 degrees and less than or equal to 9.0 degrees.

4. The power tool of claim 3, wherein the predetermined angle is greater than 0.0 degrees and less than or equal to 6.0 degrees.

5. The power tool of claim 1, wherein the predetermined angle is determined based on an orbit radius defined by a lateral distance between a longitudinally extending centerline of the drive shaft and a longitudinally extending centerline of the eccentric mass.

6. The power tool of claim 5, wherein a second surface of the platen, opposite the first surface of the platen, faces an exterior of the tool, the second surface of the platen being configured to receive an abrasive sheet engaging a finishing surface of a workpiece during operation of the power tool.

7. The power tool of claim 6, wherein the counterweight is configured to counteract forces generated due to interaction between the abrasive sheet and the finishing surface based on the position of the counterweight, the position of the counterweight being offset by the predetermined angle with respect to the orbit radius axis, and the counterweight being positioned adjacent to the first surface of the platen and proximate the second surface of the platen and the abrasive sheet coupled thereto.

8. A power tool, comprising:
a motor;
a drive shaft, a first end portion of the drive shaft being coupled to the motor;
a platen;
a retainer bearing coupled to a first surface of the platen;
an eccentric sleeve coupled to a second end portion of the drive shaft, the eccentric sleeve being coupled in the retainer bearing to eccentrically couple the drive shaft to the platen;
a counterweight coupled to the second end portion of the drive shaft, between the first surface of the platen and the eccentric sleeve; and
a mass member included on the counterweight, positioned on a peripheral diametric edge portion of the counterweight.

9. The power tool of claim 8, wherein the mass member is positioned on one side of an orbit radius axis of an eccentric mass of the tool, the eccentric mass including the eccentric sleeve, the retainer bearing and the platen coupled to the second end portion of the drive shaft.

10. The power tool of claim 9, wherein the orbit radius axis is defined by a line extending laterally through a longitudinally extending centerline of the drive shaft and a longitudinally extending centerline of the eccentric mass.

11. The power tool of claim 8, wherein the mass member is integrally formed with the counterweight as a single unit.

12. The power tool of claim 8, wherein a second surface of the platen, opposite the first surface of the platen, faces an exterior of the tool, the second surface of the platen being configured to receive an abrasive sheet engaging a finishing surface of a workpiece during operation of the power tool.

13. The power tool of claim 12, wherein the counterweight and mass member coupled thereto are configured to counteract forces generated due to interaction between the abrasive sheet and the finishing surface based on the position of the mass member on the counterweight, and the position of the counterweight adjacent to the first surface of the platen and proximate the second surface of the platen and the abrasive sheet coupled thereto.

14. The power tool of claim 12, further comprising a housing, wherein the motor, the drive shaft, the retainer bearing, the eccentric sleeve and the counterweight are received in the housing, with the first surface of the platen facing an interior of the housing.

15. A power tool, comprising:
a motor;
a drive shaft, a first end portion of the drive shaft being coupled to the motor;
a platen;
a retainer bearing coupled to the platen;
a fan coupled to the drive shaft, the fan including a first counterweight and a hub portion, the drive shaft extending through an opening in the hub portion;
a sleeve coupled to the hub portion of the fan, the sleeve being coupled in the retainer bearing; and
a second counterweight coupled to a second end portion of the drive shaft, between the first surface of the platen and the sleeve.

16. The power tool of claim 15, wherein the opening in the hub portion is eccentrically positioned in the hub portion.

17. The power tool of claim 16, wherein a mass of a first sector of the hub portion is greater than a mass of a second sector of the hub portion, such that the first sector defines the first counterweight.

18. The power tool of claim 17, wherein the first counterweight and the second counterweight are configured to counteract forces generated due to interaction between an abrasive sheet coupled to a second surface of the platen and a finishing surface of a workpiece based on a position of the first counterweight and a position of the second counterweight adjacent to the first surface of the platen and proximate the second surface of the platen and the abrasive sheet coupled thereto.
